(19) United States
(12) Patent Application Publication
(10) Pub. No.: US 2026/0149710 A1
(43) Pub. Date: May 28, 2026

(54) MULTI-WEARABLE USER AUTHENTICATION SYSTEMS AND METHODS

(71) Applicant: Purdue Research Foundation, West Lafayette, IN (US)

(72) Inventor: Sudip Vhaduri, West Lafayette, IN (US)

(73) Assignee: Purdue Research Foundation, West Lafayette, IN (US)

(21) Appl. No.: 19/380,019

(22) Filed: Nov. 5, 2025

Related U.S. Application Data
(60) Provisional application No. 63/723,980, filed on Nov. 22, 2024.

(51) Int. Cl. H04L 9/40; G06F 1/16

(52) U.S. Cl. CPC H04L 63/083; G06F 1/163

(57) ABSTRACT

A system and method for implicit user authentication using data from multiple wearable devices is disclosed. Two or more wearable devices associated with a user collect physiological and activity-related data, which is transmitted to an authentication platform that computes and selects influential features for model development. The platform generates device-level and aggregated models using machine learning classifiers to verify user identity based on the collected data. If model confidence score falls below a defined threshold, an explicit authentication step is initiated. The disclosed approach enhances security and usability by enabling continuous, burden-free authentication in Internet of Things (IoT) environments.

### CROSS-REFERENCE TO RELATED APPLICATIONS

This application is related to and claims priority benefit of U.S. Provisional Application No. 63/723,980 entitled “MULTI-WEARABLE USER AUTHENTICATION SYSTEMS AND METHODS” filed Nov. 22, 2024, the contents of which are hereby incorporated by reference in their entirety into the present disclosure.

### TECHNICAL FIELD

The present application relates generally to digital authentication technologies, and, more particularly, to systems and methods for implicit and continuous user authentication for wearable electronic devices and the Internet of Things (IoT) ecosystem using biometric data from multiple wearable devices.

### BACKGROUND

With the increased popularity of the IoT, a wide range of wearable devices are used, including fitness bands, smartwatches, smart glasses, and smart clothes. These wearables come with different types of sensors to serve different purposes, e.g., when a smartwatch can help a user to track health behaviors, a fitness band can help a user to monitor blood oxygen saturation values. Therefore, users can choose to use combinations of wearables, ranging from smartwatches to smart clothes, to obtain various types of services. While these market-wearables provide a range of services, including controlling a magnitude of physical objects, such as smart cars and homes, and managing online accounts, such as email and bank accounts, to end-users, the wearables are collecting different types of personal data and sensitive information about an end user. Thereby, in addition to providing various services, market-wearables bring additional challenges to protect end-users' privacy-sensitive information and secure access to other IoT-connected cyber-physical objects and services.

While ensuring the security of market-wearables is crucial, the majority of these devices lack robust user authentication mechanisms. Instead, they often rely on passwords, Personal Identification Numbers (PINs), pattern locks, or other knowledge-based authentication methods. This is primarily due to these compact wearables' constrained sensing and computing capabilities. Unfortunately, those knowledge-based end-user authentications for market-wearables often suffer from different inherent limitations, including human error, recall biases, and shoulder surfing risks, among others. These problems become even more acute with the rise of IoT when end-users are flooded with passwords and PINs. For example, based on a survey of over one thousand internet users, it was discovered that approximately 20% of users had encountered a compromised online account. Additionally, a staggering 70% of respondents admitted to difficulty remembering more than ten passwords.

When biometric data-driven authentications, including fingerprint scanning or face recognition, can be useful to overcome the limitations of knowledge-based authentications, most of these traditional biometric-based authentications are not adaptable to almost all popular market-wearables due to their limited display size as well as limited sensing and computing capabilities. Additionally, most of the traditional biometric-based systems rely on one-time authentication and require explicit and active user input.

Therefore, there is a need to develop end-user authentications based on various behavioral and physiological traits, including gait, step counts, calorie burn, and heart rate, which are readily available to most of the market-wearables. While the behavioral and physiological data-driven soft-biometrics can verify the end-users continuously and implicitly, there is still a growing need for a new, implicit authentication framework to provide enhanced, continuous, and unobtrusive user verification. Integration of multiple biometrics from the same wearable appears to be beneficial to verify an end-user compared to single biometrics. Combining biometric data from multiple wearables, such as a smartwatch and a fitness band, of an end-user can further increase the potential to identify the end-user uniquely. This becomes possible with the emergence of IoT and its increased connectivity. Thereby, data fusion from multiple IoT-connected wearables appears to be advantageous to the security challenges IT has brought to the end-users.

### SUMMARY

Described herein is a technical solution for an implicit, continuous, and multi-device user authentication in IoT environments, which integrates biometric data obtained from multiple wearables (uses a multi-wearable IoT authentication approach) associated with the users to create authentication models that distinguish the users from potential imposters based on patterns of physiological and behavioral signals, and to implicitly verify the users and their access to other IoT objects through the wearables, thereby securing access to the devices themselves and the broader cyber-physical space they connect to, without imposing a recall burden or requiring active user input.

In one aspect of the described embodiments, a user authentication system is provided, which can comprise at least two wearable electronic devices configured to acquire biometric data of a user, and a processor operatively coupled to the wearable electronic devices via a network connection. The processor may be configured to receive and process the acquired biometric data from one or more of the wearable electronic devices, and based on the processed biometric data, implicitly authenticate the user using a pre-trained authentication model. The pre-trained authentication model may be selected from a plurality of pre-trained authentication models, depending on available data in the processed biometric data. The plurality of pre-trained authentication models may include a multi-wearable model trained on a combination of biometric data from each of the at least two wearable electronic devices. In some embodiments, the processor may be further configured to trigger an explicit user verification process if the implicit authentication fails. In some embodiments, the explicit verification process may require a user input selected from the group consisting of: a Personal Identification Number, a password, a pattern lock, a security question answer, a one-time password, a security key, a fingerprint scan, a facial recognition scan, a voice recognition sample, and a combination thereof. In some embodiments, the processor may be further configured to compute a plurality of features from the received biometric data, generate an authentication score by inputting the plurality of features into the selected authentication model, and implicitly authenticate the user if the authentication score meets a predetermined confidence threshold. In some embodiments, the processor may be configured to initiate explicit verification of the user if the authentication score falls below the predetermined confidence threshold. In some embodiments, each wearable electronic device may comprise one or more sensors configured to collect the biometric data of the user when the wearable electronic device is worn by the user. In some embodiments, the biometric data may comprise at least one of physiological data and behavioral data. In some embodiments, the processor may be configured to operate in a continuous authentication mode while the user is wearing the at least two wearable electronic devices. In some embodiments, the at least two wearable electronic devices may comprise a first wearable device configured to collect a first set of biometric data, and a second wearable device, different from the first wearable device, configured to collect a second set of biometric data, wherein at least a portion of the second set of biometric data is different from the first set of biometric data. In some embodiments, the plurality of pre-trained authentication models may further include device-level models, each device-level model associated with and trained using biometric data from a respective wearable electronic device of the at least two wearable electronic devices. In some embodiments, the at least one processor may be configured to select the authentication model by selecting the multi-wearable model when the biometric data is received from at least two of the wearable electronic devices when concurrently worn by the user, and select, from the device-level models, a specific device-level model associated with a single wearable device when the biometric data is received only from the single wearable device. In some embodiments, the processor may be further configured to segment each stream of the received biometric data into a series of time-synchronized data windows before computing the plurality of features. In some embodiments, the received biometric data may comprise heart rate data, and the processor may further be configured to determine a heart rate zone for each heart rate data window and include the heart rate zone as one of the plurality of features. In some embodiments, the processor may further be configured to perform a feature selection process to select a subset of influential features from the plurality of features before inputting them into the selected authentication model. In some embodiments, the selected authentication model may be a binary classifier or a unary classifier. In some embodiments, the feature selection process may comprise removing redundant features from the plurality of features to create a set of non-redundant features, and subsequently select the subset of influential features from the set of non-redundant features based on one of: principal component analysis for the binary classifier or lowest variance for the unary classifier. The redundant feature may be one that exhibits a correlation with another feature above a predefined correlation threshold. In some embodiments, the binary classifier is a support vector machine with a radial basis function kernel.

In another aspect of the described embodiments, a system for multi-wearable user authentication is provided. The system may comprise: a plurality of wearable electronic devices configured to be worn by a user, wherein each device comprises one or more sensors configured to collect biometric data; and at least one processor operatively coupled to the plurality of wearable electronic devices via a network connection. The at least one processor may be configured to: receive a stream of biometric data from one or more of the plurality of wearable electronic devices, wherein the biometric data comprises at least one of physiological data or behavioral data; compute a plurality of features from the stream of biometric data; select an authentication model from a plurality of pre-trained models based on which one or more of the plurality of wearable electronic devices are providing the stream of biometric data, wherein the plurality of pre-trained models includes a multi-wearable model trained on a combination of biometric data from at least two different wearable electronic devices of the plurality of wearable electronic devices; generate an authentication score by inputting the plurality of features into the selected authentication model; and implicitly authenticate the user if the authentication score meets a predetermined confidence threshold.

In one more aspect of the described embodiments, a method of implicit user authentication in an Internet of Things (IoT) environment is provided. The method may comprise the following steps: collecting a stream of biometric data from one or more wearable electronic devices of a plurality of wearable electronic devices worn by a user; computing, by at least one processor, a plurality of features from the collected stream of biometric data; selecting, by the at least one processor, an authentication model from a plurality of pre-trained models based on which one or more of the plurality of wearable electronic devices provided the stream of biometric data, wherein the plurality of pre-trained models includes a multi-wearable model trained on a combination of biometric data from at least two different types of wearable electronic devices of the plurality of wearable electronic devices; generating an authentication score by inputting the plurality of features into the selected authentication model; and implicitly authenticating the user if the authentication score meets a predetermined confidence threshold. In some embodiments, the method may further comprise the steps of: segmenting, by the at least one processor, the stream of biometric data into time-synchronized data windows; and computing, by the at least one processor, the plurality of features for each of the time-synchronized data windows. In some embodiments, the method may further comprise the step of triggering, by the at least one processor, an explicit user verification process if the implicit authentication fails. In some embodiments of the method, the authentication model may be selected by the at least one processor by prioritizing the multi-wearable model when the biometric data is available from a plurality of wearable electronic devices. The multi-wearable model may be pre-trained to provide a higher authentication accuracy than any single device-level model associated with and trained using biometric data from a single wearable electronic device of the plurality of wearable electronic devices.

The disclosed systems and methods improve device and network security by introducing multi-source, data-driven authentication capable of adapting to different physical and behavioral conditions of the user. The disclosed authentication approach provides higher accuracy, lower false acceptance rates, and greater robustness compared to single-wearable and knowledge-based authentication techniques.

This summary is provided to introduce a selection of the concepts that are described in further detail in the detailed description and drawings contained herein. This summary is not intended to identify any primary or essential features of the claimed subject matter. Some or all of the described features may be present in the corresponding independent or dependent claims but should not be construed to be a limitation unless expressly recited in a particular claim. Each embodiment described herein does not necessarily address every object described herein, and each embodiment does not necessarily include each feature described. Other forms, embodiments, objects, advantages, benefits, features, and aspects of the present disclosure will become apparent to one of skill in the art from the detailed description and drawings contained herein. Moreover, the various systems and methods described in this summary section, as well as elsewhere in this application, can be expressed as a large number of different combinations and sub-combinations. All such useful, novel, and inventive combinations and sub-combinations are contemplated herein, it being recognized that the explicit expression of each of these combinations is unnecessary.

### BRIEF DESCRIPTION OF THE DRAWINGS

While the specification concludes with claims which particularly point out and distinctly claim this technology, it is believed this technology will be better understood from the following description of certain examples taken in conjunction with the accompanying drawings, in which like reference numerals identify the same elements and in which:

FIG. 1 is a block diagram representing schematically a system for multi-wearable data-driven IoT authentication, in accordance with the present disclosure.

FIG. 2 is a flow diagram illustrating a multi-wearable data-driven IoT authentication method performed using the system shown in FIG. 1.

FIG. 3 is an overview of a particular example of the multi-wearable data-driven IoT authentication modeling approach.

FIG. 4 is a chart showing summary of Two-Sample T-tests while distinguishing a subject from 24 other subjects in the same heart rate zones using oxygen saturation (SpO2) level.

FIG. 5 is a chart showing summary of Two-Sample experimental tests while distinguishing pairs of subjects in the same heart rate zones using heart rate data from a first wearable device, a second wearable device, and their combination at 0.05 level of significance.

FIG. 6A is a chart showing an effect of a feature count on a multi-wearable (WF) model performance based on support vector machine (SVM) classifier coming with a binary scheme with radial basis function (RBF).

FIG. 6B is a chart showing an effect of a feature count on a multi-wearable model performance based on SVM classifier coming with a unary scheme with RBF.

FIG. 7A is a spider chart visualization of binary second wearable device (W)-level models.

FIG. 7B is a spider chart visualization of binary first wearable device (F)-level models.

FIG. 7C is a spider chart visualization of binary WF models.

FIG. 8A is a spider chart visualization of unary W models.

FIG. 8B is a spider chart visualization of unary F models.

FIG. 8C is a spider chart visualization of unary WF models.

FIG. 9 shows charts with relative gain of W, F and WF different models, with prefix “B” and “U” in the legends representing binary and unary classifiers/models.

FIG. 10A is a chart showing probability density function (PDF) and cumulative distribution function (CDF) analysis results of genuine acceptance rate (GAR) score.

FIG. 10B is a chart showing PDF and CDF analysis results of true rejection rate (TRR) score.

FIG. 11A is a chart showing error rate variation with the change of model confidence probabilities.

FIG. 11B is a chart showing sample count variation with the change of model confidence probabilities.

The drawings are not intended to be limiting in any way, and it is contemplated that various embodiments of the technology may be carried out in a variety of other ways, including those not necessarily depicted in the drawings. The accompanying drawings incorporated in and forming a part of the specification illustrate several aspects of the present technology, and together with the description serve to explain the principles of the technology; it being understood, however, that this technology is not limited to the precise arrangements shown, or the precise experimental arrangements used to arrive at the various graphical results shown in the drawings.

### DETAILED DESCRIPTION OF THE ILLUSTRATED EMBODIMENTS

The following description of certain examples of the technology should not be used to limit its scope. Other examples, features, aspects, embodiments, and advantages of the technology will become apparent to those skilled in the art from the following description, which is by way of illustration, one of the best modes contemplated for carrying out the technology. As will be realized, the technology described herein is capable of other different and obvious aspects, all without departing from the technology. Accordingly, the drawings and descriptions should be regarded as illustrative in nature and not restrictive.

It is further understood that any one or more of the teachings, expressions, embodiments, examples, etc. described herein may be combined with any one or more of the other teachings, expressions, embodiments, examples, etc. that are described herein. The following described teachings, expressions, embodiments, examples, etc., should, therefore, not be viewed in isolation relative to each other. Various suitable ways in which the teachings herein may be combined will be readily apparent to those of ordinary skill in the art in view of the teachings herein. Such modifications and variations are intended to be included within the scope of the claims.

As used herein, a “wearable device” or “wearable” refers to an electronic device, capable of being worn on the human body, which comprises one or more sensors, a processing unit, and a communication module for transmitting collected data via a network.

The term “configured” is used in the present disclosure as broadly encompassing initial configuration, later adaptation or complementation of components of the present system, or any combination thereof alike, whether effected through material or software means (including firmware).

With the emergence of the IoT and the advancement of sensing technologies, market wearables are equipped with different types of sensors ranging from accelerometers to photoplethysmography (PPG) sensors that can continuously capture end-users' physiological and behavioral traits. Thereby, the market-wearables, such as Apple Watch®, Fitbit®, etc. are used to accomplish a range of activities (e.g., physical activity and mobility monitoring, fitness tracking, heart and blood disorder monitoring) and services (e.g., bank transactions and email checking) in addition to accessing various IoT-connected cyber-physical objects, such as cars, smart homes, through these smartwatches. Though market-wearables provide all those services based on end-users' privacy-sensitive personal information, most of these market wearables either do not have any user authentication or have knowledge-based authentications, such as PINs, patterns locks, or passwords, which are inherently suffered from various limitations, including recall burdens. In the age of IoT, this recall burden has become very acute since end-users are flooded with PINs, pattern locks, and passwords. While biometric-based authentications can overcome most of the limitations of the knowledge-based approaches, almost all traditional biometrics, such as fingerprint scanning, face recognition, breathing patterns, eye tracking, touch patterns, and keystroke dynamics, are inconvenient to transform to tiny wearables due to their small display along with limited computing and sensing capabilities. Hence, different types of physiological and behavioral data, including heart rate, step counts, gait, electric muscle stimulation, calorie burn, blood oxygen saturation values, and wrist motion are considered for IoT wearable user authentication. However, most of these behavioral biometric-based approaches fail when the end-user is sedentary. Additionally, some prototypical physiological biometrics, e.g., electric muscle stimulation, are not available in most of the market wearables. Furthermore, some biometric data, such as electrocardiogram (ECG) capture, requires end-users to actively interact with the device, e.g., touch a part of the device with the second hand to complete an electrical circuit; thereby, such biometrics cannot be used for non-stop implicit authentication system design.

Therefore, various easily obtainable data, such as heart rate, step counts, gait, calorie burn, and blood oxygen saturation values are considered in the disclosed solution, which can be found in most of the market-wearables to develop continuous and implicit end-user authentications. In line with this direction, it was found that combining multiple biometrics can be beneficial over a single biometric while identifying an end-user during both sedentary and non-sedentary periods due to higher availability and complementary information gain. Similarly, integration of biometrics from multiple IoT-connected wearables of an end-user can further improve the performance of end-user authentications since biometrics from different wearables can complement each other to identify the end-user uniquely.

The disclosed solution presents an end-user authentication approach that combines biometric data obtained from multiple wearables (multi-wearable IoT authentication (briefly referred to as “mWIoTAuth”) approach) to implicitly verify the users and their access to other IoT objects through the wearables.

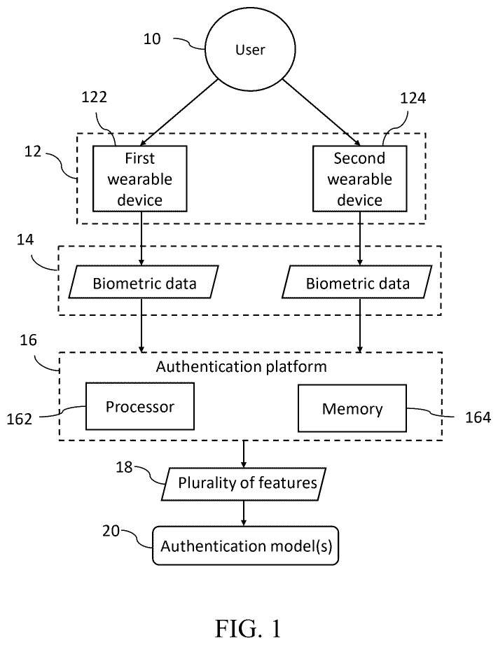

FIG. 1 generally illustrates a system for multi-wearable data-driven IoT authentication of a user 10, in accordance with the present disclosure. The system comprises two or more wearable devices 12 configured to be worn by the user 10 and to collect biometric data 14. The two or more wearable devices 12 may comprise a first wearable device 122 configured to collect a first set of biometric data 14 and a second wearable device 124, different from the first wearable device 122, configured to collect a second set of biometric data 14. At least a portion of the second set of biometric data 14 may be different from the first set. In some embodiments, the one or more sensors are configured to collect the biometric data 14 of the user 10 when the wearable electronic device 12 is worn by the user.

Specifically, the wearable devices 12 are electronic devices configured to digitally sense (collect), process, record, and/or transmit the biometric data 14. Each device 12 typically includes a power source, one or more sensors, a processor, and a communication module (e.g., Bluetooth, Wi-Fi). In some embodiments, each of the wearable devices 12 may be selected from the group consisting of: a smartwatch, a fitness tracker, a smart ring, a smart garment, a head-mounted display, smart glasses, a smart patch, a hearing aid, a smart necklace, and a smart earring. However, any other electronic devices configured to collect user biometric data 14 can be applicable.

The biometric data 14 may comprise physiological and/or behavioral signal data. The physiological and/or behavioral signal data may be collected using one or more sensors of the two or more wearable devices 12. In some embodiments, the one or more sensors may be selected from the group consisting of: a PPG sensor, an accelerometer, a gyroscope, a magnetometer, an ECG sensor, a galvanic skin response (GSR) sensor, an electromyography (EMG) sensor, a skin temperature sensor, an ambient light sensor, a barometer, a Global Positioning System (GPS) receiver, and an inertial measurement unit (IMU) comprising one or more of the foregoing.

In some embodiments, the collected biometric data 14 may be selected from the group consisting of: heart rate, heart rate variability (HRV), blood oxygen saturation (SpO₂), step count, calorie expenditure, gait pattern, respiration rate, blood pressure, electrodermal activity, skin temperature, sleep stage data, activity type, activity intensity level, and location traces. In some embodiments, each wearable electronic device 12 may be configured to measure at least one of heart rate, SpO₂, step count, or calorie burn.

The system further comprises an authentication platform 16 operatively connected to the wearable electronic devices 12 via a network. Preferably, the authentication platform 16 may comprise at least one processor 162 configured to operatively connect via the network and communicate with the wearable devices 12, and a memory 164 configured to store computer-executable instructions to compute a plurality of features 18 from data streams 14 received from the wearable devices 12. In some embodiments, the network connection may be selected from the group consisting of: a wireless personal area network (WPAN) connection, a wireless local area network (WLAN) connection, a cellular network connection, and a combination thereof. In some particular embodiments, the network connection may be selected from a Bluetooth® connection, a Bluetooth® low energy (BLE) connection, a Wi-Fi connection or a cellular network connection.

The at least one processor 162 is configured to: receive the sets of biometric data 14 collected by the wearable devices 12; compute the plurality of features 18 from the received data 14; input the plurality of features 18 into one or more authentication models 20; and implicitly authenticate the user 10 based on an output of at least one of the one or more authentication models 20. The implicit authentication does not require active user input.

Preferably, the one or more authentication models 20 comprise a multi-wearable model trained using a combination of two or more or the sets of biometric data 14 collected by the two or more wearable devices 12 respectively. The one or more authentication models 20 may comprise a plurality of models including each device-level model and the multi-wearable model. In some embodiments, each device-level model is associated with and trained using biometric data 14 from a respective wearable electronic device 122, 124 of the at least two wearable electronic devices 12.

In some embodiments, the at least one processor 162 may be configured to select the authentication model 20 by selecting the multi-wearable model when the biometric data 14 is received from at least two of the wearable electronic devices 12 when concurrently worn by the user 10, and select, from the device-level models, a specific device-level model associated with a single wearable device when the biometric data 14 is received only from the single one of the wearable devices 12.

In some preferable embodiments, the at least one processor 162 is configured to compute at least one of accuracy, true rejection rate (TRR), genuine acceptance rate (GAR), or F1 score to evaluate authentication model performance, as will be discussed in more details below. In some preferable embodiments, the multi-wearable model provides a higher GAR and a higher TRR than any single device-level model.

In some embodiments, the at least one processor 162 may be further configured to perform feature count optimization to avoid model overfitting and underfitting.

In some embodiments, the at least one processor 162 may also be configured to train authentication models 20 using a plurality of labeled datasets comprising data from valid users and imposters. In some embodiments, the authentication platform 16 may comprise a cloud server configured to perform model training and update the wearable electronic devices 12 with authentication parameters. In some embodiments, the at least one processor 162 may be further configured to distinguish between users based on statistical relationships among data obtained from multiple body locations.

In some embodiments, the at least one processor 162 can comprise a machine learning model configured to process the received data associated with the wearable devices 12, including the collected biometric data 14, authenticate users, and/or train the authentication models 20. More specifically, in some embodiments, the processor can comprise a neural processing unit (NPU), also known as artificial intelligence (AI) accelerator or deep learning processor, which is a class of specialized hardware accelerator or computer system designed to accelerate artificial intelligence and machine learning applications, including artificial neural networks and computer vision.

In some embodiments, the at least one processor 162 may be configured to trigger an explicit user verification process if the implicit authentication fails. Particularly, the system can be configured to ask the user 10 to validate through an explicit validation approach. In some embodiments, the explicit validation can be selected from the group consisting of: a knowledge-based authentication, a possession-based authentication, a biometric-based authentication, and a combination thereof. The knowledge-based authentication may comprise entering a PIN, a password, a pattern lock, or answering a security question. The possession-based authentication may comprise validating a one-time password (OTP) sent to a registered email address or mobile device, or using a security key. The biometric-based authentication may comprise a one-time fingerprint scan, a facial recognition scan, or a voice recognition sample. A combination of explicit validation approaches may comprise multi-factor authentication (MFA), such as requiring both a PIN and a fingerprint scan.

In some embodiments, the at least one processor 162 may be configured to operate in a continuous authentication mode while the user 10 is wearing at least two wearable electronic devices 12.

In some embodiments, the at least one processor 162 may fuse data from the wearable electronic devices 12 based on temporal synchronization windows. In a particular embodiment, the at least one processor 162 may be further configured to segment each stream of the received biometric data 14 into a series of time-synchronized data windows before computing the plurality of features 18. In some embodiments, the received biometric data may comprise heart rate data, and the processor 162 may further be configured to determine a heart rate zone for each heart rate data window and include the heart rate zone as one of the plurality of features 18.

In some embodiments, the at least one processor 162 may further be configured to perform a feature selection process to select a subset of influential features from the plurality of features before inputting them into the selected authentication model 20. In some embodiments, the selected authentication model 20 may be a binary classifier or a unary classifier. In some embodiments, the binary classifier is a support vector machine (SVM) with a radial basis function (RBF) kernel, which will be discussed below in more details.

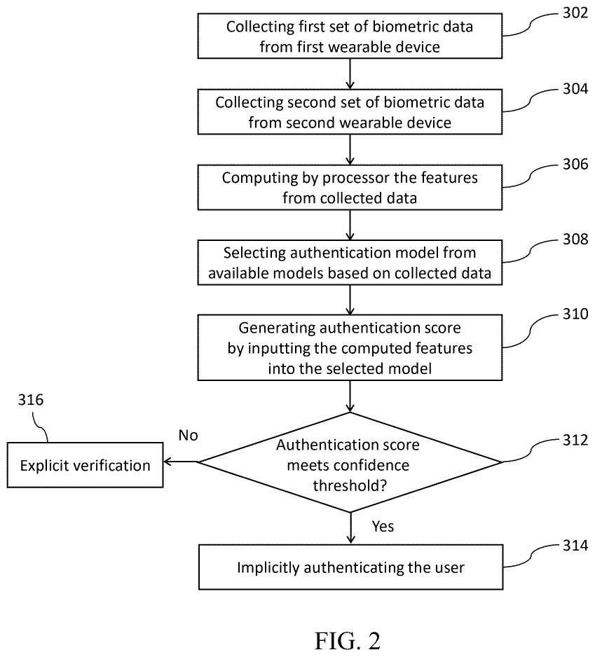

FIG. 2 generally illustrates a multi-wearable data-driven IoT authentication method flow in accordance with the present disclosure. The method may be performed by a system such as the system for multi-wearable data-driven IoT authentication of the user 10, described above with reference to FIG. 1. The method proceeds through the following general operational steps.

At operation 302, the first set of biometric data 14 from the first wearable device 122 worn by the user 10 is collected.

At operation 304, the second set of biometric data 14 from the second wearable device 124 worn by the user 10 is collected. Optionally, if more than two wearable devices are worn by the user 10, the set of biometric data 14 from each next wearable device 122 worn by the user 10 is collected.

At operation 306, a plurality of features 18 from the first, second, and optionally, each next set of biometric data 14 is computed, by the authentication platform 16, preferably by the at least one processor 162.

At operation 308, an authentication model 20 is selected from a plurality of available models based on availability of data 14 from the wearable devices 12. The authentication model 20 may be selected from a plurality of pre-trained authentication models, depending on available data in the processed biometric data 14. The plurality of available models includes the multi-wearable model trained on the combination of data from the first, second and optionally, each next of the wearable devices 12 worn by the user 10.

At operation 310, an authentication score is generated by inputting the plurality of features 18 into the selected authentication model 20. In some embodiments, a feature selection process is also performed to select a subset of influential features from the plurality of features 18 before inputting them into the selected authentication model 20. In some embodiments, the feature selection process may comprise removing redundant features from the plurality of features 18 to create a set of non-redundant features, and subsequently select the subset of influential features from the set of non-redundant features based on one of: principal component analysis for the binary classifier or lowest variance for the unary classifier. The redundant feature may be one that exhibits a correlation with another feature above a predefined correlation threshold.

At decision operation 312, it is determined whether the authentication score meets a predetermined confidence threshold.

If the authentication score meets a predetermined confidence threshold, at operation 314, the user 10 is implicitly authenticated by the authentication platform 16.

In some embodiments, if the authentication score does not meet the predetermined confidence threshold, at operation 316, the user 10 performs explicit verification.

In some embodiments, the authentication platform 16 may be configured to dynamically select the most appropriate authentication model 20 based on the real-time availability of data 14 from the wearable devices 12. Preferably, where data 14 is available from all the wearable devices 12, the multi-wearable model is selected to provide the highest level of security and accuracy. However, the system may be designed to be fault-tolerant. In some embodiments, if data 14 from one of the wearable devices 12 becomes unavailable—for instance, due to the device being removed, a sensor error, or a low battery—the platform 16 may automatically falls back to using the corresponding device-level model. This ensures that implicit user authentication can continue uninterrupted based on the available wearable device, maintaining security even in a degraded state until full functionality is restored.

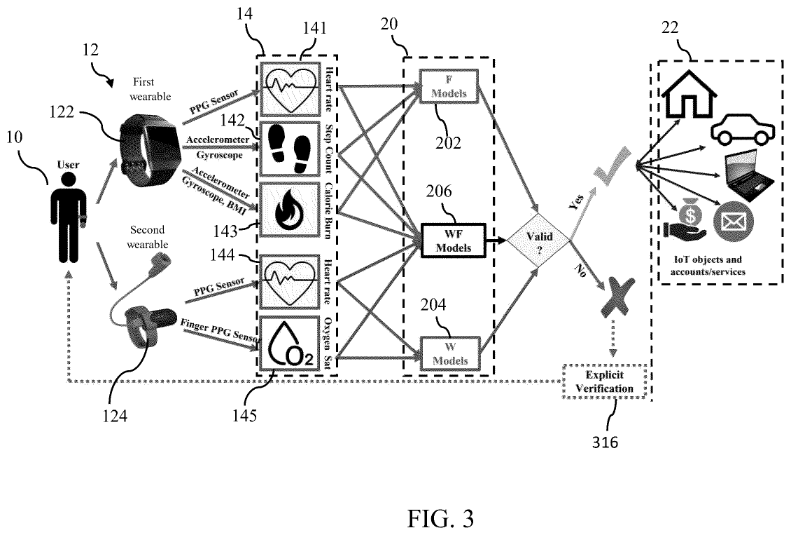

The user authentication system and method as shown in FIGS. 1 and 2 are advantageous for the following reasons. Due to the higher connectivity of the smart wearables 12, users 10 are highly exposed to intensified security threats. Eventually, these smart wearables 12 will pose security threats to not only the individual user 10 but also other users, as well as the community, nation, and globe with which the individual user 10 interacts. As the users 10 can access both physical spaces, e.g., smart homes and smart cars, among several others, and cyberspaces, e.g., financial transactions and emails, among several others, through these smart wearables 12, an entire cyber physical space 22 (as shown in FIG. 3) is facing the intensified security challenges. With the rise of IoT and the enhancement of smart sensing and computing, there is a trend to receive a magnitude of services from tiny smart wearables 12. At the same time, these small devices 12 and their connectivity to cyber-physical space 22 are very difficult to secure due to their limited or absence of display, which may be required implementing existing user verification schemes. The user authentication system and method as shown in FIGS. 1 and 2 enables these devices 12 automatically verify a wearer (user 10) by utilizing collected data and alleviating the need for active user input. In the case of wearables 12, when the device 12 is worn may impact the collected data. Therefore, the proposed implicit authentication system is configured to be kicked in when the user 10 wears the devices 12, and after that, it is configured to keep track of whether the session is still active, i.e., the user 10 is still wearing the setup and whether any other person is trying to get access. The core of this authentication system is authentication models 20, where device-level and aggregated models are configured to try to verify the identity of the user 10 based on the features 18 computed from the biometric data 14 obtained from the devices 12 the user 10 is wearing. If, at any point, the implicit verification approach fails after a few attempts, an explicit verification (operation 316) will be popped up to reset the scheme. The authentication scheme as explained with reference to FIGS. 1 and 2 is burden-free and easily adaptable.

FIG. 3 presents an overview of a particular example of the multi-wearable data-driven IoT authentication modeling system, in accordance with the present disclosure, which enables to implicitly verify a user 10, by utilizing data 14 obtained from two personal smart wearable electronic devices (wearables) 12 of the user 10. In this particular example, the first wearable 122 is a smart watch (FitBit Ionic 2® smart watch will be tested below) and the second wearable 124 is a wrist pulse oxymeter (Wellue SleepU® pulse oximeter will be tested below). This example will be used to explain the proposed authentication system and method in details below, based on performed tests and obtained results.

According to the multi-wearable IoT user authentication scheme illustrated in FIG. 3, initially, device-level models 202, 204 are created using the data 14 acquired from one of two smart wearables 122, 124, either the first wearable 122 (FitBit Ionic 2® device), or the second wearable 124 (Wellue SleepU® device). Subsequently, the process progresses to develop multi-device models 20 by utilizing the data 14 collected from both of these wearables 122, 124.

As depicted in FIG. 3, the following single-wearable models 202, 204 and multi-wearable models 206 are developed utilizing the data 14 collected from the wearables 122, 124: Fitbit® (first wearable) data-dependent models (referred to as “F models”) 202, Wellue® (second wearable) data-dependent models (referred to as “W models”) 204, and Wellue® and Fitbit® (first and second wearable) data-dependent models (referred to as “WF models”) 206.

In this example, when W models 204 are trained with heart rate data 144 and oxygen saturation (SpO₂) data 145 obtained from the Wellue® device 124, F models 202 are trained with heart rate data 141, step count data 142, and calorie burn data 143 obtained from the Fitbit® device 122. The combined WF models 206 are trained with the two types of Wellue® data 144, 145 and three types of Fitbit® data 141, 142, 143. To develop different models, the authentication system can utilize a set of classification learners introduced below. Based on the availability of wearables 12, one of the three models can be used to try to validate the user 10. Once the user 10 is validated, the user 10 is enabled to get access to all other IoT-connected objects and accounts/services (cyber physical space) 22. Otherwise, the system is configured to ask the user 10 to validate through an explicit validation approach (explicit verification 316), such as PIN, pattern locks, passwords, etc.

The experimental data was collected from Wellue® device 124 and Fitbit® device 122, as shown in FIG. 3, in two distinct phases, adhering to approved procedures by the Institutional Review Board (IRB) under the IRB ID: 1855. Subjects participated voluntarily, and they did not receive any incentives. In the first phase, eight continuous hours of data were collected from 25 healthy subjects (36.6±18.7 years of average age). This data was used to experiment with parameters, features, and multi-wearable data-driven IoT authentication modeling. The robustness was tested (in terms of true rejection rate) of the multi-wearable data-driven IoT authentication models using a second phase of data collection from a set of 15 subjects (average age of 34±18.5 years) separate from the 25 subjects considered in the first phase. During this second phase, there was followed the same protocol as used in the first phase. Throughout the entire study period, participants wore both wearables 122, 124 continuously in their daily life. Wellue® device 124 recorded heart rate 144 and oxygen saturation 145 readings from the fingertip every four seconds, resulting in a sampling frequency 0.25 Hz (one sample every four seconds). On the other hand, Fitbit® device 122 captured calorie burn 143, heart rate 141, and step count data 142 from the wrist every five seconds, leading to a sampling frequency of 0.2 Hz (one sample every five seconds). While heart rate data 141, 144 and oxygen saturation data 145 were collected using the PPG sensors on Wellue® device 124 and Fitbit® device 122, calorie burn data 143 and step count data 142 were collected using the accelerometer and gyroscope sensors on the Fitbit® device 122. Wellue® device 124 first stored data 144, 145 locally on the device 124, and then the data 144, 145 was offloaded to a laptop using a USB connector. Fitbit® device 122 first sent data 141, 142, 143 to its server, and later, Fitbit® data 141, 142, 143 was downloaded from the server as JavaScript Object Notation (JSON) files and then parsed to obtain desired data.

The participants wore the Wellue® device 124 and Fitbit® device 122 for an extended period in their daily life. Therefore, often collected data 14 was affected by various factors, including sensor malfunctions and motion artifacts. These led to missing or invalid data. Sometimes it took a while for the Wellue® device 124 to stabilize when a user transited between two activity levels, and at that time, heart rate values were recorded as 65535, which are way higher than the valid maximum heart rates. These invalid entries were removed and considered missing data. Out of the 8 h of data, an average of ≈5% (24 min) data was missing at the subject level. Similar to Wellue® data, Fitbit® data cleaning was also performed. In the case of this dataset, no missing or invalid data was found from Fitbit® device 122. After cleaning the raw data, the continuous heart rate data 141, 144 obtained from both wearables 122, 124 was segmented into five separate person-specific heart rate zones (defined in Table 1 below) based on an individual's maximum heart rate, which has an association with that individual's demographics and physical activity levels. These individualized heart rate zone-based segmented data were used to perform statistical tests discussed below. Finally, the clean raw data was segmented into time-synchronized (i.e., same start time) 50-second non-overlapped windows, which were found to be a good compromise to compute different statistical features and develop models. Furthermore, a representative heart rate zone was extracted by employing majority voting. This involved considering the zones associated with all samples in a window and determining the reference point feature for that specific window based on the majority vote.

TABLE 1
Heart rate (HR) zones and their ranges.

| | Ranges |
|---|---|
| HR Zones | % of max HR |

| Numerical | Categorical | of a subject |
|---|---|---|
| 1 | very light | 50-60 |
| 2 | light | 60-70 |
| 3 | moderate | 70-80 |
| 4 | intense | 80-90 |
| 5 | very intense | 90-100 |

To understand the effectiveness of utilizing SpO₂ data 145 in the models 20, Two-Sample T-tests were used to compare one subject against the other N−1=24 subjects at a specific heart rate (HR) zone based on phase-1 data, with the null hypothesis, H0:

$${μ}_{i}^{k} = {μ}_{∀ j \neq i}^{k} ,$$

where

$${μ}_{i}^{k} and {μ}_{∀ j \neq i}^{k}$$

are average heart rate values obtained from subject-i and all other subjects except subject-i at zone-k with i, j∈{1, 2, . . . , 25}, j≠i, and k∈{1, 2, 3, 4, 5}. At 0.05 level of significance, the null hypothesis was rejected if the average oxygen saturation value of a subject was not the same as the average oxygen saturation value obtained from the rest of the 24 subjects at a specific heart rate zone, i.e., the average oxygen saturation values at that specific heart rate zone differentiated the subject from the remaining 24 subjects.

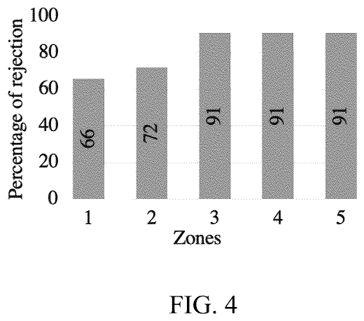

FIG. 4 presents aggregated findings using the Two-Sample T-tests across the five heart rate zones. In FIG. 4, it is observed that from moderate to highly intensive heart rate zones, the null hypothesis is rejected in 91% cases. However, lightly active heart rate zones (i.e., both very light and light zones) have lower rejection percentages, indicating that differentiation in those zones is not as prevalent using only SpO2 data. Overall, an average rejection rate of 82% was obtained across all five heart rate zones while comparing each subject with the remaining 24 subjects. However, while comparing pairs of subjects and their average oxygen saturation values at a specific heart rate zone (with the null hypothesis, H0:

$${μ}_{i}^{k} = {μ}_{j}^{k} ,$$

where,

$${μ}_{i}^{k} and {μ}_{j}^{k}$$

are average heart rate values obtained from subject-i and subject-j at zone-k with i, j∈{1, 2, . . . , 25}, j≠i, and k∈{1, 2, 3, 4, 5}), an average rejection rate of 92% was obtained. High rejection rates while using oxygen saturation data to distinguish individuals indicate that the data can be useful in an authentication scheme.

The Two-Sample T-tests were considered to determine whether pairs of subjects can be better distinguished using heart rate data 141, 144 obtained from the two wearables 122, 124 compared to a single wearable at a specific zone. Two separate tests were first performed for Fitbit® heart rate data 141 and Wellue® heart rate data 144, and then there were combined the test results obtained from the two devices 122, 124 utilizing 25 subjects from phase-1. The Two-Sample T-tests compared the average heart rate measures of pairs of subjects within a distinct heart rate zone under a null hypothesis, H0:

$${μ}_{i}^{d k} = {μ}_{j}^{d k} ,$$

where

$${μ}_{i}^{d k} and {μ}_{j}^{d k}$$

are average heart rate values obtained from subject-i and subject-j at zone-k using the d device (i.e., i, j∈{1, 2, . . . , 25}, j≠i, k∈{1, 2, 3, 4, 5}, and d∈{Wellue®, Fitbit®}). At 0.05 level of significance, the null hypothesis was rejected if the average heart rate measures of a pair of subjects were not the same at a distinct heart rate zone, i.e., the average heart rate measures of that subject pair at that distinct heart rate zone differentiated the subjects. Subsequently, the outcomes obtained from all possible pairs of subjects were combined by counting the number of rejections and then normalized by dividing them by the total number of comparisons. This process provides with an assessment of the goodness, where higher values indicate better utilization of the heart rate data 141, 144 from each individual device 12 and their combination.

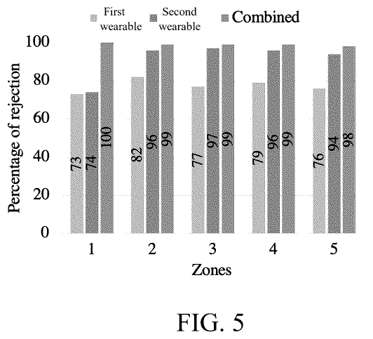

The results of the Two-Sample T-tests are displayed in FIG. 5, which illustrates the percentage of rejections (distinguishable subject-pairs) across different heart rate zones using data obtained from the Fitbit® device (first wearable) 122 and Wellue® device (second wearable) 124. It is observed that combined cases usually perform better than individual devices since the combined data from two devices 122, 124 can complement each other and increases the chances of identifying an individual uniquely from others. At zone-1, the combined case is capable of distinguishing 35% more subject pairs than either of the devices 122, 124 alone. In general, the combined heart rate data offers a higher range compared to the single device-based cases. While the two devices 122, 124 have separate sampling frequencies (e.g., 0.25 Hz versus 0.2 Hz), these devices 122, 124 also collect data from different body parts (i.e., fingertip versus wrist). This way, pairs of wearables 12 capture more information about a user utilizing the same (e.g., heart rate data 141, 144) or different (e.g., oxygen saturation data 145 versus calorie burn data 143 and step count data 142) types of data 14 generated from different sensors (e.g., PPG sensor versus accelerometer and gyroscope).

The feature extraction approach, which is followed by the selection of non-redundant and influential features, will now be described.

Feature computation. From a single window of samples (the earlier segmented time-synchronized 50-second non-overlapped windows), a set of 21 statistical features was computed as an initial feature set. While 21 heart rate features and 21 oxygen saturation features were computed from a Wellue® (second wearable) window, from a Fitbit® (first wearable) window, 21 heart rate features, 21 calorie burn features, and 21 step count features were computed. The representative heart rate zone (i.e., the heart rate zone with most samples in a window) was also considered an additional feature. Therefore, the initial set consisted of 43 and 64 features when using first wearable and second wearable device biometrics separately. Finally, 106 (i.e., 105 statistical and one heart rate zone) features were computed from time-synchronized Fitbit® and Wellue® windows.

Feature selection. A two-step process was followed to select the influential features. In the first step, one feature was randomly dropped from each pair of highly correlated (i.e., Pearson correlation over 0.9) features. Depending on binary versus unary classifiers, different schemes were followed for the second step when finding influential features from a set of uncorrelated features obtained in the first step. For binary classifiers, when trying the second step of feature selection with two separate approaches, i.e., the “Select the K-Best” approach and principal component analysis approach using sci-kit learn, the latter approach was found to outperform the former. Similarly, for unary classifiers, a separate variance-based feature selection approach was adopted since there was only one class of data compared to the binary case. In this variance-based approach, a set of influential features were picked based on the lowest variance. The optimal number of features for model development is discussed below in respect of the feature count optimization.

For authentication model development, a list of performance metrics, model training-testing schemes, parameter optimization, and feature count optimization schemes were used as described below.

The following list of metrics was considered to evaluate the performance of different modeling schemes: accuracy (ACC), True Rejection Rate (TRR), Genuine Acceptance Rate (GAR), F₁ Score, Root Mean Square Error (RMSE), Area Under the Curve-Receiver Operating Characteristic (AUC-ROC), and Equal Error Rate (EER).

ACC is the fraction of correct predictions, defined as below,

$$A C C = ( T P + T N ) * {( T P + F N + F P + T N )}^{- 1} \qquad ( 1 )$$

TRR is the fraction of invalid user instances rejected by an authentication model, which is the inverse of the False Acceptance Rate (FAR), i.e.,

$$TRR = ( T N ) * {( F P + T N )}^{- 1} = 1 - F A R \qquad ( 2 )$$

GAR is the fraction of target user instances correctly identified by an authentication model, which is the inverse of the False Rejection Rate (FRR), i.e.,

$$G A R = ( T P ) * {( T P + F N )}^{- 1} = 1 - FRR \qquad ( 3 )$$

F₁ Score is a performance metric that combines the positive predictive value (also known as precision) and true positive rate (also known as recall) measures of a model, i.e.:

$${F}_{1} Score = 2 {( \frac{T P}{T P + F N} + \frac{T P}{T P + F P} )}^{- 1} \qquad ( 4 )$$

RMSE is a metric used to measure the deviations between the predicted values and the original values. In another way, it is one type of misclassification rate, i.e.,

$$R M S E = \sqrt{\frac{F P + F N}{T P + F N + F P + T N}} \qquad ( 5 )$$

AUC-ROC is the graphical relationship between the False Acceptance Rate (FAR) and False Rejection Rate (FRR) with the change of confidence thresholds of correct predictions.

EER is a trade-off between the FAR and FRR error measures. It is the point when FRR and FAR are equal. Since FAR and FRR reflect the security and usability measures, the EER point eventually presents a trade-off between security and usability.

The terminologies used in Equations (1)-(5) carry their standard meanings in machine learning, specifically when referring to the process of identifying a user based on a given feature set.

Additionally, spider chart area (SC-Area) was considered, which is a combined metric derived from a set of positive metrics, e.g., ACC, TRR, GAR, F₁ Score, and AUC-ROC, when presented graphically using a spider chart. Each metric, ranging from zero to one, present a dimension in a polygon in the spider chart, and the area (SC-Area) within the polygon characterizes the shape of the polygon. In this disclosure, the spider chart is either a pentagon (binary models with five measures) or a quadrilateral (unary models, excluding the AUC-ROC measure). To facilitate comparison between binary and unary models, the computed area within a polygon is normalized by dividing the area of a polygon with a score of 1, on a [0,1] scale, across all dimensions.

An ideal authentication model should exhibit lower values for negative metrics (such as RMSE, FAR, FRR, and EER) and higher values for positive metrics (such as ACC, F₁ Score, GAR, TRR, AUC-ROC, and SC-Area).

Model training-testing schemes. During the multi-wearable IoT user authentication model training and testing based on phase-1 data, a pick-one-subject strategy was followed, where one subject was picked out of the N=25 subjects as a valid user (i.e., class-1) and the rest of the N−1=24 subjects were considered as imposters (i.e., class-0). Thereby, N models were developed, one for each subject. During training-testing, a 90%-10% sequential split between the training and test sets were adopted. Thereby, the 10% test data comes from the later part of the 8-hour continuous data collection from an individual. Compared to a random split, this sequential split better resembles a real-life situation where a pre-trained model is used/deployed later. In the case of binary models, the same number of samples was picked from the imposter and valid user classes to ensure class balancing. For the imposter class, samples were uniformly picked from the N−1 subject. In contrast to binary models, unary models were developed exclusively using data from valid users, incorporating an outlier rate (ν) to segregate the user's data into valid set and outlier set.

Classification learners. When developing different multi-wearable IoT user authentication models, a range of classification learners was considered, such as random forest (RF), the support vector machine (SVM), Naive Bayes (NB), and k-nearest neighbor (k-NN). Compared to other classifiers, the SVM comes with both binary and unary schemes with two major kernel functions, i.e., radial basis function (RBF) and polynomial (Poly.) kernels defined by below:

$$Poly . Kernel , K ( {y}_{i} , {y}_{j} ) = {( 1 + γ {y}_{i}^{T} {y}_{j} )}^{d} \qquad ( 6 )$$

$$RBF Kernel , K ( {y}_{i} , {y}_{j} ) = {e}^{- γ {y}_{i}^{T} {y}_{j}} \qquad ( 7 )$$

where γ and d denote the “scale parameter” and “degree” parameter, with yᵢ and yⱼ denoting the two feature vectors. Also, the parameter C is used to indicate the penalty/cost associated with the incorrect classifications.

Hyper-parameter optimization. An exhaustive “grid search” scheme was followed to decide the most suitable hyper-parameter values when developing the multi-wearable IoT user authentication models. While developing one of the N=25 models, a 3-fold crossvalidation scheme was adopted to find the optimal values of different parameters from a wide spectrum of values, including degree, d∈[1,5] with 1 increment (SVM Poly), γ∈[0.01, 0.09] with 0.01 increment (SVM RBF), C∈[1, 19] with 1 increment (SVM), number of neighbors, k∈[2, 38] with 1 increment (k-NN), number of estimators, n∈[50, 200] with 50 increment (RF), and outlier rate, ν∈[0.05, 0.75] with 0.05 increment (unary SVM). Since similar values were obtained from different runs, the optimal values are presented of various hyper-parameters observed across different runs when presenting performance analysis of multi-wearable IoT user authentication models below.

Feature count optimization. The approaches to finding the set of influential features are presented above, the optimal number of features will now be demonstrated to develop (i.e., train) multi-wearable IoT user authentication models using 90% data with a goal to avoid overfitting and underfitting. Starting from 10, different feature counts were tried from a set of initial features that were used to develop different models. For example, while determining the optimal counts for the binary and unary WF models 206, 10, 20, 30, 40, 50, 60, and 70 features (excluding the window-level heart rate zone feature used as a reference point) were tried from the initial set of 106 features using the best unary and binary models.

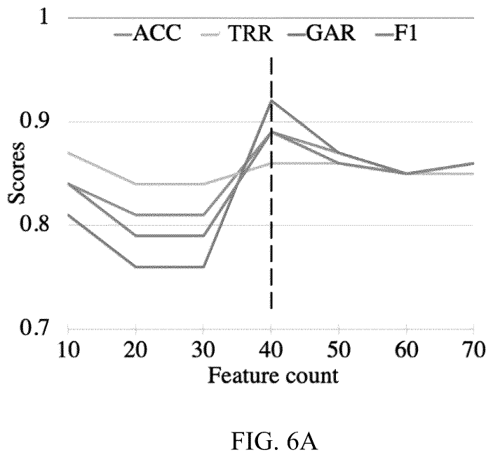

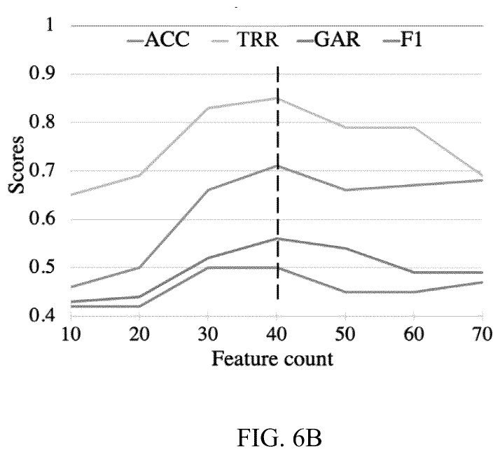

FIGS. 6A and 6B present different performance scores obtained while developing (i.e., training) WF (i.e., combined wearable) models 206 using both Wellue® and Fitbit® data 14. In FIG. 4A, a sharp raise from 30 to 40 and a sharp drop from 40 to 50 are observed across all performance measures. In FIG. 4B, a similar trend is also observed. Thereby, 40 (without the reference point) or 41 (with the reference point) is considered as a good compromise for the WF models 206. However, while developing models from a single wearable 12 (Wellue® or Fitbit®), 31 is found as a good compromise.

In the case of W models 204, it was found that out of the total 30 features (excluding the heart rate zone reference point feature) 18 (i.e., 60%) and 12 (i.e., 40%) features are from heart rate data 144 and oxygen saturation data 145, respectively. However, for F models 202, it was found that out of total 30 features, 10 features (i.e., ≈33%) come from each data type, i.e., heart rate data 141, calorie burn data 143, and step count data 142. For the combined WF models 206, out of the 40 features, it was found that 10 features (6 heart rate and 4 oxygen saturation) and 30 features (10 heart rate, 9 calorie burn, and 11 step count) come from Wellue® and Fitbit®, respectively. Therefore, the same distribution is observed among the features of an individual device 12 as before. However, while comparing the devices 122, 124 in the combined setup, it was found that Fitbit® device 122 has more features than Wellue® device 124.

The one-sided proportion test was performed with the null hypothesis, H₀: p_{F}=p_{W} and alternative hypothesis, H₀: p_{F}>p_{W}, where p_{F}=30/63=0.48 and p_{W}=10/42=0.24 are the fraction of total Fitbit® and Wellue® features, respectively. At 0.05 level of significance, the null hypothesis is rejected with z=2.4612 and p-value=0.00695<0.05/2=0.025. Therefore, Fitbit® has more features than Wellue® in the combined WF models 206.

To illustrate multi-wearable IoT user authentication model evaluation, a comparison of the multi-wearable IoT user authentication modeling approaches is presented below, with comparison of the approaches with benchmarks.

Model comparison. Different classifiers were used to compare the three modeling schemes (i.e., W model 204, F model 202, and WF model 206). Before presenting the detailed analysis of the models trained using different classifiers, an analysis is presented based on the aggregated spider chart area (SC-Area) measure that was used to combine multiple performance measures and select the best classifiers.

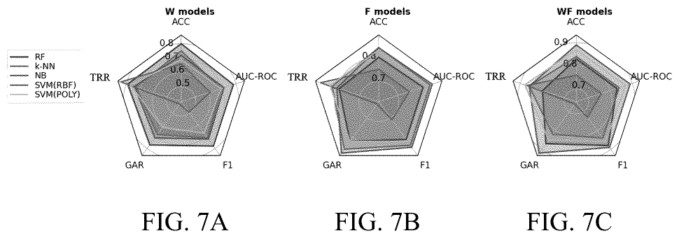

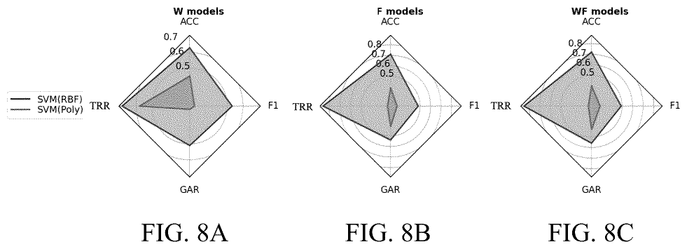

FIGS. 7A-7C and 8A-8C utilize spider charts to graphically present different performance measures to understand the trade-offs of the various measures better and choose the best models. In the case of binary models, while the SVM (RBF) classifier-based F and WF models 202, 206 are found to achieve the best SC-Area, random forest (RF) classifier-based W model 204 achieves the best SC-Area (see FIGS. 7A-7C). Similar to binary, the SVM (RBF) classifier-based unary models are found to always achieve the best SC-Area (see FIGS. 8A-8C). This way, SVM (RBF) is selected as the best classifier for all models except the binary W model 204, where the RF classifier performs the best. It is to be noted that binary models outperform the unary models by almost two times.

Next, there is presented an analysis of different authentication models chosen based on the classifiers (with optimal parameter values). The single wearable-based models are presented in Tables 2 and 3, and the multi-wearable models are presented in Table 4. When assessing the performance of Wellue® data-driven W models 204, random forest (RF) is found as the best classifier for the binary models. Compared to binary, the unary classifiers achieve lower performances. SVM (RBF) is found as the best unary classifier. This is intuitive since the unary models are developed with data obtained from single class, and thereby, unary models are inexperienced with as much imposter training compared to the binary models.

TABLE 2
Performance summary of W models with 31 features [average (standard deviation)].

| Classifiers | | | | | | AUC- | SC- |
|---|---|---|---|---|---|---|---|
| (parameters) | ACC | RMSE | TRR | GAR | F₁ Score | ROC | Area |
| Binary | | | | | | | |
| RF (n = 50) | .80 (.09) | .04 (.01) | .79 (.14) | .77 (.12) | .78 (.09) | .78 (.10) | .61 |
| k-NN (k = 2, | .75 (.01) | .04 (.01) | .73 (.17) | .68 (.11) | .71 (.09) | .69 (.11) | .49 |
| minkowski | | | | | | | |
| distance) | | | | | | | |
| NB | .66 (.07) | .05 (.01) | .84 (.16) | .42 (.16) | .49 (.12) | .61 (.08) | .38 |
| SVM (RBF | .72 (.13) | .04 (.01) | .74 (.17) | .71 (.14) | .72 (.13) | .71 (.13) | .52 |
| kernel, γ = | | | | | | | |
| 0.08, C = 3 | | | | | | | |
| SVM (Poly. | .69 (.10) | .04 (.01) | .77 (.16) | .62 (.13) | .67 (.11) | .69 (.11) | .50 |
| kernel, d = | | | | | | | |
| 4, C = 16 | | | | | | | |
| Unary | | | | | | | |
| SVM (RBF | .63 (.08) | .05 (.01) | .69 (.27) | .51 (.25) | .53 (.16) | N/A | .37 |
| kernel, γ = | | | | | | | |
| 0.05, ν = 0.5 | | | | | | | |
| SVM (Poly. | .45 (.10) | .06 (.01) | .58 (.32) | .28 (.22) | .29 (.17) | N/A | .19 |
| kernel, d = | | | | | | | |
| 1, ν = 0.75 | | | | | | | |

TABLE 3
Performance summary of F models with 31 features [average (standard deviation)].

| Classifiers | | | | | | AUC- | SC- |
|---|---|---|---|---|---|---|---|
| (parameters) | ACC | RMSE | TRR | GAR | F₁ Score | ROC | Area |
| Binary | | | | | | | |
| RF (n = 200) | .80 (.09) | .05 (.02) | .79 (.13) | .82 (.09) | .81 (.08) | .81 (.09) | .65 |
| k-NN (k = 5, | .84 (.07) | .05 (.02) | .82 (.09) | .86 (.09) | .84 (.07) | .84 (.07) | .70 |
| minkowski | | | | | | | |
| distance) | | | | | | | |
| NB | .75 (.10) | .06 (.02) | .87 (.13) | .63 (.13) | .71 (.11) | .75 (.10) | .55 |
| SVM (RBF | .84 (.09) | .05 (.02) | .80 (.12) | .88 (.08) | .85 (.08) | .85 (.09) | .71 |
| kernel, γ = | | | | | | | |
| 0.05, C = 5 | | | | | | | |
| SVM (Poly. | .83 (.07) | .05 (.01) | .83 (.12) | .82 (.09) | .82 (.07) | .83 (.07) | .68 |
| kernel, d = | | | | | | | |
| 2, C = 19 | | | | | | | |
| Unary | | | | | | | |
| SVM (RBF | .71 (.13) | .06 (.02) | .86 (.20) | .54 (.15) | .48 (.26) | N/A | .42 |
| kernel, γ = | | | | | | | |
| 0.05, ν = 0.5 | | | | | | | |
| SVM (Poly. | .39 (.21) | .09 (.02) | .25 (.30) | .41 (.22) | .28 (.18) | N/A | .11 |
| kernel, d = | | | | | | | |
| 2, ν = 0.05 | | | | | | | |

TABLE 4
Performance summary of WF models with 41 features [average (standard deviation)].

| Classifiers | | | | | | AUC- | SC- |
|---|---|---|---|---|---|---|---|
| (parameters) | ACC | RMSE | TRR | GAR | F₁ Score | ROC | Area |
| Binary | | | | | | | |
| RF (n = 150) | .83 (.07) | .05 (.02) | .80 (.14) | .87 (.07) | .88 (.07) | .83 (.08) | .68 |
| k-NN (k = 2, | .84 (.07) | .06 (.02) | .86 (.08) | .82 (.08) | .84 (.07) | .84 (.07) | .71 |
| minkowski | | | | | | | |
| distance) | | | | | | | |
| NB | .76 (.09) | .06 (.02) | .87 (.11) | .66 (.13) | .73 (.10) | .76 (.09) | .57 |
| SVM (RBF | .89 (.06) | .04 (.01) | .86 (.09) | .92 (.05) | .89 (.06) | .89 (.06) | .80 |
| kernel, γ = | | | | | | | |
| 0.05, C = 5 | | | | | | | |
| SVM (Poly. | .87 (.06) | .04 (.01) | .88 (.10) | .85 (.08) | .86 (.06) | .87 (.06) | .75 |
| kernel, d = | | | | | | | |
| 3, C = 19 | | | | | | | |
| Unary | | | | | | | |
| SVM (RBF | .72 (.11) | .06 (.02) | .85 (.15) | .56 (.18) | .49 (.27) | N/A | .45 |
| kernel, γ = | | | | | | | |
| 0.05, ν = 0.5 | | | | | | | |
| SVM (Poly. | .40 (.09) | .10 (.00) | .24 (.32) | .43 (.27) | .29 (.15) | N/A | .11 |
| kernel, d = | | | | | | | |
| 2, ν = 0.05 | | | | | | | |

Next, the performance of Fitbit® data-driven F models 202 was assessed. SVM (RBF) classifier-based F model was found to be the best F model and the SVM (RBF) F model was found to be more robust than the best W model. The F model was 5% more (i.e., (0.84−0.8)/0.8*100%) accurate compared to the W model. Additionally, the TRR and GAR are increased by 1.3% (i.e., (0.80−0.79)/0.79*100%) and 14.3% (i.e., (0.88−0.77)/0.77*100%), respectively. Similar to binary, the best unary F model (i.e., SVM (RBF)) also outperforms the best unary W model. The best unary F model was found to have around 13% higher ACC, 25% higher TRR, 6% higher GAR, and 13% higher SC-Area than the best unary W model. While W and F models 204, 202 were developed using the same number of features, F features were computed from three separate data types (heart rate data 141, calorie burn data 143, and step count data 142) compared to W models 204, where features were computed from two types of data, i.e., heart rate data 144 and blood oxygen saturation values 145. Thereby, authentication performance can be improved with the availability of diverse data types since they increase the chances of uniquely identifying an individual.

Finally, the performance of WF models 206 developed by combining data 14 obtained from Wellue® and Fitbit® was assessed. Drastic performance improvement was observed for WF models 206 compared to single device data-driven W models 204 or F models 202. The best binary WF model (i.e., SVM (RBF)) achieves 14% and 6% higher ACC compared to the best binary W and F models, respectively. Similarly, TRR is increased by 8%, GAR is increased by 8%, and SC-Area is increased by 13% compared to the best binary F model. In the case of unary models, SC-Area is increased by 7% when comparing the best unary WF model with the best unary F model. Thereby, these findings demonstrate the promise of using multi-wearable data to develop a robust user authentication system.

Though a model can achieve the best performance across one performance measure, it may lose performance across other measures. Therefore, a model was selected based on one of the three major performance measures, i.e., GAR (usability measure), TRR (security measure), and SC-Area (overall measure), to get a deeper insight of how much performance the model loses across other measures. The goal is to choose a model that obtains a balanced performance across all three major measures.

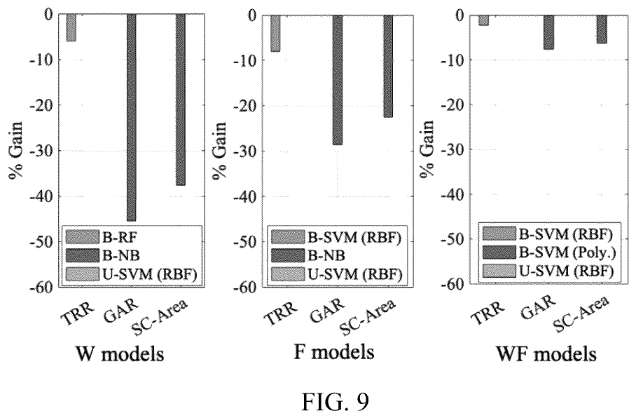

In FIG. 9, the models are compared that achieve the highest GAR, TRR, and SC-Area scores as presented in Tables 2-4. For each performance measure, the gain (i.e., performance improvement) of a model was first computed with respect to the score of the best model. Thereby, the best model has a gain of 0. Additionally, negative gain means loss. Binary and unary models are compared separately. Since the unary SVM (RBF) classifier-based models always achieve the best scores across all three performance measures, SVM (RBF) classifier-based unary models have 0 gain, represented by bars with 0 height. However, in the case of binary models, no model was found to achieve the best scores across all three measures. In Tables 2-4, RF, SVM (RBF), and SVM (RBF) were found to be the best classifiers while developing binary W, F, and WF models, respectively. While each of these models achieves the best GAR and SC-Area scores (represented by bars with 0 height in FIG. 7), they suffer across TRR, ranging from 2%-8% loss. However, the binary models that achieve the best TRR struggle across the two other measures with ranges 6%-38% (loss in SC-Area) and 7%-45% (loss in TRR) as reflected in the height of the corresponding bars. Therefore, the best binary models have a more balanced performance than other binary models. While comparing the performance of the three best models, i.e., W, F, and WF models, in FIG. 7, it was found that the multi-wearable data-driven WF model 206 achieves a more balanced performance compared to two single wearable data-driven W and F models 204, 202, considering the gain/loss across the three major performance metrics.

Next, the probability density function (PDF) and cumulative distribution function (CDF) analysis of GAR and TRR scores obtained from different models was performed.

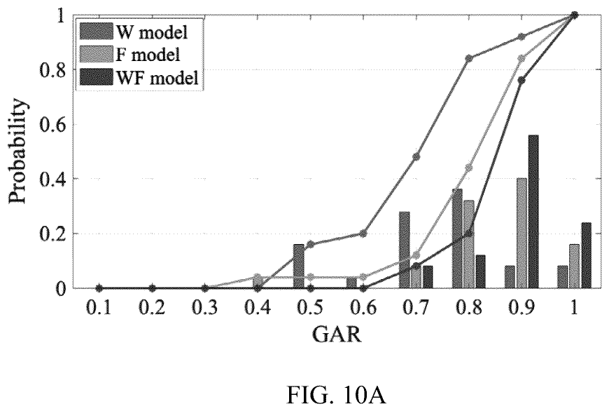

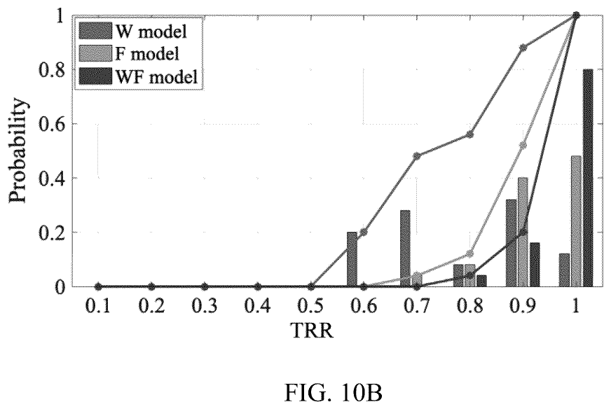

In FIG. 10A, it is observed that the dominant ranges of subject-level GAR scores obtained from the best binary W, F, and WF models are (0.6, 0.8], (0.7, 0.9], and (0.8, 1], respectively.

Similarly, in FIG. 10B, it is observed that the dominant ranges of subject-level TRR scores of the best binary W models 204 are (0.5, 0.7] and (0.8, 0.9]. Compared to W models 204, F and WF models 202, 206 have higher ranges, i.e., (0.8, 1] (F models 162) and (0.9, 1] (WF models 206). Thereby, this clearly demonstrates the strength of multi-wearable data-driven WF models 206 over the single wearable data-driven F or W models 202, 204 as well as the strength of F models 202 over the W models 204.

Benchmark Comparison. Table 5 shows that the multi-wearable implicit IoT authentication (mWIoTAuth) scheme according to the present disclosure achieves similar accuracy compared to the Comparative approach 1 (multi-modal biometric-based implicit authentication of wearable device users). However, Comparative approach 1 developed two separate sets of models for sedentary and non-sedentary cases, unlike the mWIoTAuth that can equally be utilized during both sedentary and non-sedentary cases based on wearable availability. Furthermore, in the multi-device-based approach, biometrics from one wearable 12 can be complementary to biometrics from other wearable 12 when one wearable 12 malfunctions.

TABLE 5
Benchmark comparison summary.

| | | | Need direct | Sedentary & |
|---|---|---|---|---|
| | Average | Device | user | non-sedentary |
| Ref. | accuracy | integration | interaction? | applicability? |
| mWIoTAuth | .89 | Yes | No | Both sedentary |
| | | | | & non-sedentary |
| Comparative | .9-.93 | No | No | Sedentary or |
| approach 1 | | | | non-sedentary |
| Comparative | 1.0 | No | No | Non-sedentary |
| approach 2 | | | | |
| Comparative | .99 | No | Yes | Sedentary or |
| approach 3 | | | | near-sedentary |

Though the other benchmark works (Comparative approaches 2 and 3) achieve higher accuracy than the proposed approach, they are limited to only non-sedentary cases (Comparative approach 2 (activity and gait recognition with time-delay embeddings) or require active user interaction (Comparative approach 3 (continuous user identification via touch and movement behavioral biometrics)) unlike the mWIoTAuth scheme, which seamlessly utilizes physiological and behavioral data obtained from multiple wearables 12 to validate a user 10. Thereby, the mWIoTAuth scheme precludes the need for any active user input. Furthermore, authentication approaches that utilize screen touch and movement are not appropriate for non-sedentary cases (Comparative approach 3) since users usually are less interactive with the screen when they are non-sedentary. Also, smartwatches have a smaller display to adapt this approach. Therefore, the mWIoTAuth can be complementary to existing benchmarks when developing an implicit IoT authentication.

Error rate analysis. A comparison is presented among the three best binary models (i.e., W, F, and WF models) based on security (measured in terms of FAR=1−TRR) and usability (measured in terms of FRR=1−GAR) trade-off.

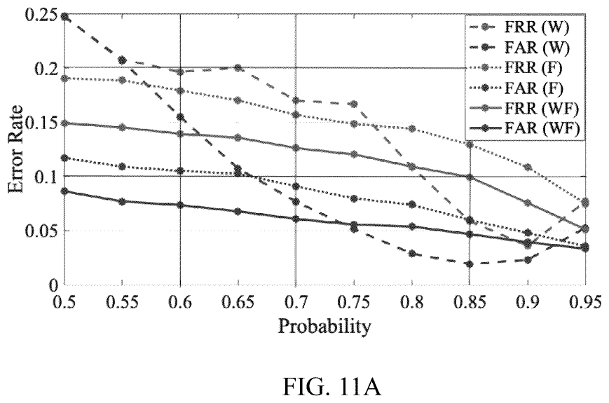

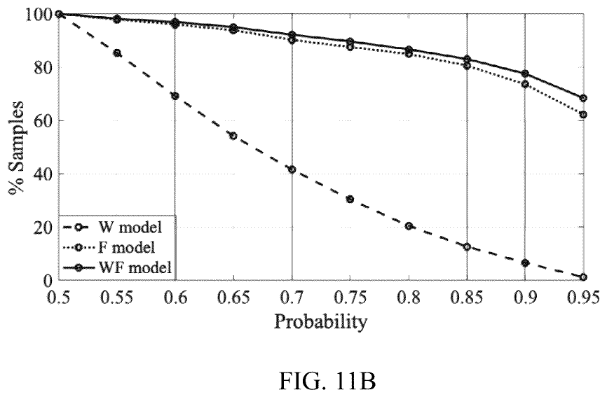

In FIG. 11A, it is observed that every model has a better security score than its associated usability score, i.e., FAR scores are lower than their associated FRR scores. It is also observed that with the increase in decision probability, models are performing better both in terms of usability and security. However, any cross-over between the two measures of any model is observed, thereby, there is no equal error rate (ERR) in the experiment.

It was found that with an increase of confidence probability above 0.6, models 16 are able to make decisions with error rates (both FRR and FAR) lower than 0.2, and with an increase of the decision probability above 0.7, all models 16 are able to achieve a security improvement, i.e., FAR drops below 0.1. On the other hand, models struggle with usability scores, i.e., FRR. When W and WF models 204, 206 achieve an FRR score lower than 0.1 at a confidence threshold of 0.85, the FRR score of the F model 202 still remains above 0.1. Noticeably, at the 0.85 confidence threshold, the FAR scores of all models get close to 0.05, which is a very robust security score. While the W model 204 shows an increase both in FRR and FAR after 0.85 confidence threshold, those scores could be affected and biased by some spurious values since at 0.9 confidence threshold W model 204 finds only 6% of the total samples to calculate the scores, compared to 73% and 77% samples that are used to calculate scores for F and WF models 202, 206, respectively (see FIG. 11B). While the W model 204 presents a sharp drop in sample count with the increase of confidence thresholds, F and WF models 202, 206 show a gradual drop. Therefore, a confidence threshold of 0.85 can be a good compromise to make a trade-off between usability and security measures. However, the confidence threshold can be lowered to 0.7 if one only focus on the security measure. Similar to the previous cases, multi-wearable data-driven WF model 206 was found to have a better error rate than the single-wearable data-driven W and F models 204, 202.

Model robustness analysis. The robustness (in terms of the true rejection rate (TRR)) analysis of the three subject-level authentication models (i.e., W, F, and WF models) developed with phase-1 data collected from 25 valid users was performed. In this experiment, a set of imposters comprised of 15 phase-2 subjects (class-0) was first developed. Next, for each valid user, it was tried to determine how well the model can detect the 15-imposter data mimicking an attack made by a group of attackers who are trying to access the devices 12 and the entire cyber-physical space 22 accessible via the system. While the authentication model has no prior knowledge about the imposters, combined data from a group of 15 imposters makes it even more challenging for the models to validate access.

In general, lower average TRR scores at phase-2 are observed compared to the average TRR scores at phase-1 across all three models (i.e., W, F, and WF models). However, all these phase-2 average TRR scores are around 0.8, i.e., close to phase-1 TRR values mentioned in Tables 2-4.

The range of TRR scores are: [0.73,0.80] (W models 204), [0.75,0.81] (F models 202), and [0.76,0.82] (WF models 206). That is, multi-wearable data-driven models are more robust to a group of unknown imposters than the single wearable models. Thereby, data obtained from multiple wearables can be prioritized while developing models.

Furthermore, two cohorts of subjects, i.e., attacker from phase-2 and valid subjects from phase-1, are homogeneous. Therefore, their biometric data have similarities, which makes it even harder for models to distinguish imposters from valid users. So, the findings presented in this robustness analysis could potentially define the lower bond of robustness, which could go up when an individual heterogeneous imposter tries to attack the system in real-world.

The following limitations can be noted with respect of the developed multi-wearable implicit IoT authentication approach.

Context-dependency of biometrics. Compared to traditional biometrics, soft biometrics, such as heart rate, vary with context changes ranging from physical activity to stress. However, reference points, such as activity levels or heart rate zones, have been commonly used to reflect those contexts and their changes. Similarly, heart rate zones are considered as a reflection of physiological arousal due to various factors, including physical activity, stress, and others, when computing features from the eight hours of continuous biometric data collected from the active part of the day consisting of both sedentary and non-sedentary periods. Thereby, the developed dataset and models still capture the context variations in daily life and their effect on biometrics.

Practical relevance of soft biometric-based implicit authentication. Compared to one-time authentication using traditional biometrics, soft biometrics are continuous and can implicitly validate a user without active involvement. For example, when biometrics, such as ECG, requires active user interaction with the wearable (i.e., touch certain of a smartwatch with the non-dominant hand to complete an electric circuit to get the readings) and require powerful sensors to capture precise millisecond-level data for template matching, soft wearable-biometrics, such as heart rate, are usually collected in less informative coarse-grained (i.e., second-level) format with less powerful wearable sensors without requiring any active user interaction. But these soft biometrics can still validate a user.

Need for continuous wearable-user authentication. The existing one-time wearable-user verification using smartphones cannot perform continuous user authentication. After verification, if the wearable is transferred to a different user, the existing authentication system cannot detect this. Therefore, developing continuous and implicit authentication for wearable users is advantageous. When a single coarse-grained biometric may not be good enough to validate a user, their combination from multiple devices can complement each other, and if one does not work, the other can still validate the user. Therefore, such continuous authentications can complement smartphone-based one-time authentications.

Support for multi-wearable implicit authentication. With the emergence of the IoT, an increased number of smart wearables is used, including smartwatches, smart glasses, smart clothes, and smart shoes, among many others. While each wearable is designed to serve a specific purpose, they collect different data types using a unique set of low-power sensors and coordinate with a companion app on a user's smartphone to connect to the backend server. A collaborative authentication approach can be used where a simple rule-based classification model implemented in the wearables will perform the first screening, and if it fails to validate a user, more complex and powerful models using neural networks implemented in smartphones will be kicked in. This way, with its computing power, the gateway smartphone brings opportunities to uniquely identify a user based on similar type or different type data collected from multiple wearables of the same user. Multiple modalities of a user collected from different wearables can capture a user's unique and distinctive properties to complement each other when identifying the user. How exactly these combinations complement requires additional investigation. Additionally, when a modality or a wearable does not function, other wearables can still validate the user implicitly and continuously in the IoT world where a non-stop security threat is prevalent.

Sensor data gaps. While data gaps are common in sensors, depending on the size of missing or invalid data, either regression model, such as generalized linear mixed model-based interpolation can be considered to infer possible values during the missing period, or secondary data from the same or different time-synchronized wearables or other devices can be used to infer possible values during the missing period.

Multi-wearable implicit IoT authentication approach advantageously uses data from two wearables to implicitly authenticate an individual. From the detailed analysis of daily life data collected from two separate cohorts of subjects in two phases, it was found that the SVM (RBF) classifier-based WF model is more accurate than the single device data-driven W and F models, respectively. The WF model also has higher dominant ranges of GAR and TRR scores compared to W and F models. Additionally, it was found that WF models are more resilient against the zero-knowledge gang attacks compared to their single device models, i.e., W and F models.

While examples, one or more representative embodiments and specific forms of the disclosure have been illustrated and described in detail in the drawings and foregoing description, the same is to be considered as illustrative and not restrictive or limiting. The description of particular features in one embodiment does not imply that those particular features are necessarily limited to that one embodiment. Some or all of the features of one embodiment can be used in combination with some or all of the features of other embodiments as would be understood by one of ordinary skill in the art, whether or not explicitly described as such. One or more exemplary embodiments have been shown and described, and all changes and modifications that come within the spirit of the disclosure are desired to be protected.

I/We claim:

1. A user authentication system, comprising:
at least two wearable electronic devices configured to acquire biometric data of a user; and
a processor operatively coupled to the wearable electronic devices via a network connection, wherein the processor is configured to:
receive and process the acquired biometric data from one or more of the wearable electronic devices; and
based on the processed biometric data, implicitly authenticate the user using a pre-trained authentication model;
wherein the pre-trained authentication model is selected from a plurality of pre-trained authentication models, depending on available data in the processed biometric data, the plurality of pre-trained authentication models including a multi-wearable model trained on a combination of biometric data from each of the at least two wearable electronic devices.

2. The system of claim 1, wherein the processor is further configured to trigger an explicit user verification process if the implicit authentication fails.

3. The system of claim 2, wherein the explicit verification process requires a user input selected from the group consisting of: a Personal Identification Number, a password, a pattern lock, a security question answer, a one-time password, a security key, a fingerprint scan, a facial recognition scan, a voice recognition sample, and a combination thereof.

4. The system of claim 1, wherein the processor is further configured to:
compute a plurality of features from the received biometric data;
generate an authentication score by inputting the plurality of features into the selected authentication model; and
implicitly authenticate the user if the authentication score meets a predetermined confidence threshold.

5. The system of claim 4, wherein the processor is configured to:
initiate explicit verification of the user if the authentication score falls below the predetermined confidence threshold.

6. The system of claim 1, wherein each wearable electronic device comprises one or more sensors configured to collect the biometric data of the user when the wearable electronic device is worn by the user.

7. The system of claim 1, wherein the biometric data comprises at least one of physiological data and behavioral data.

8. The system of claim 1, wherein the processor is configured to operate in a continuous authentication mode while the user is wearing the at least two wearable electronic devices.

9. The system of claim 1, wherein the at least two wearable electronic devices comprise:
a first wearable device configured to collect a first set of biometric data; and
a second wearable device, different from the first wearable device, configured to collect a second set of biometric data, wherein at least a portion of the second set of biometric data is different from the first set of biometric data.

10. The system of claim 1, wherein the plurality of pre-trained authentication models further includes device-level models, each device-level model associated with and trained using biometric data from a respective wearable electronic device of the at least two wearable electronic devices, and
wherein the at least one processor is configured to select the authentication model by:
selecting the multi-wearable model when the biometric data is received from at least two of the wearable electronic devices when concurrently worn by the user;
selecting, from the device-level models, a specific device-level model associated with a single wearable device when the biometric data is received only from the single wearable device.

11. The system of claim 4, wherein the processor is further configured to segment each stream of the received biometric data into a series of time-synchronized data windows before computing the plurality of features.

12. The system of claim 11, wherein the received biometric data comprises heart rate data, and the processor is further configured to determine a heart rate zone for each heart rate data window and include the heart rate zone as one of the plurality of features.

13. The system of claim 4, wherein the processor is further configured to perform a feature selection process to select a subset of influential features from the plurality of features before inputting them into the selected authentication model.

14. The system of claim 13, wherein the selected authentication model is a binary classifier or a unary classifier, and wherein the feature selection process comprises:
removing redundant features from the plurality of features to create a set of non-redundant features, wherein a redundant feature is one that exhibits a correlation with another feature above a predefined correlation threshold; and
subsequently selecting the subset of influential features from the set of non-redundant features based on one of: principal component analysis for the binary classifier or lowest variance for the unary classifier.

15. The system of claim 14, wherein the binary classifier is a support vector machine with a radial basis function kernel.

16. A system for multi-wearable user authentication, the system comprising:
a plurality of wearable electronic devices configured to be worn by a user, wherein each device comprises one or more sensors configured to collect biometric data; and
at least one processor operatively coupled to the plurality of wearable electronic devices via a network connection, the at least one processor configured to:
receive a stream of biometric data from one or more of the plurality of wearable electronic devices, wherein the biometric data comprises at least one of physiological data or behavioral data;
compute a plurality of features from the stream of biometric data;
select an authentication model from a plurality of pre-trained models based on which one or more of the plurality of wearable electronic devices are providing the stream of biometric data, wherein the plurality of pre-trained models includes a multi-wearable model trained on a combination of biometric data from at least two different wearable electronic devices of the plurality of wearable electronic devices;
generate an authentication score by inputting the plurality of features into the selected authentication model; and
implicitly authenticate the user if the authentication score meets a predetermined confidence threshold.

17. A method of implicit user authentication in an Internet of Things environment, the method comprising:
collecting a stream of biometric data from one or more wearable electronic devices of a plurality of wearable electronic devices worn by a user;
computing, by at least one processor, a plurality of features from the collected stream of biometric data;
selecting, by the at least one processor, an authentication model from a plurality of pre-trained models based on which one or more of the plurality of wearable electronic devices provided the stream of biometric data, wherein the plurality of pre-trained models includes a multi-wearable model trained on a combination of biometric data from at least two different types of wearable electronic devices of the plurality of wearable electronic devices;
generating an authentication score by inputting the plurality of features into the selected authentication model; and
implicitly authenticating the user if the authentication score meets a predetermined confidence threshold.

18. The method of claim 17, further comprising:
segmenting, by the at least one processor, the stream of biometric data into time-synchronized data windows; and
computing, by the at least one processor, the plurality of features for each of the time-synchronized data windows.

19. The method of claim 17, further comprising:
triggering, by the at least one processor, an explicit user verification process if the implicit authentication fails.

20. The method of claim 17, wherein the authentication model is selected by the at least one processor by prioritizing the multi-wearable model when the biometric data is available from a plurality of wearable electronic devices,
wherein the multi-wearable model is pre-trained to provide a higher authentication accuracy than any single device-level model associated with and trained using biometric data from a single wearable electronic device of the plurality of wearable electronic devices.
